(19) United States
(12) Patent Application Publication
(10) Pub. No.: US 2026/0161365 A1
(43) Pub. Date: Jun. 11, 2026

(54) METHOD AND SYSTEM FOR PERFORMING ANALYSIS OF CODE DEPLOYMENT

(71) Applicant: JPMorgan Chase Bank, N.A., New York, NY (US)

(72) Inventor: Devaraj Naga Chandra SEKHAR, Anantapur (IN)

(73) Assignee: JPMorgan Chase Bank, N.A., New York, NY (US)

(21) Appl. No.: 19/033,975

(22) Filed: Jan. 22, 2025

(30) Foreign Application Priority Data
Dec. 6, 2024 (IN) 202411096459

(51) Int. Cl. G06F 8/30

(52) U.S. Cl. CPC G06F 8/30

(57) ABSTRACT

A method and system for performing an analysis of a code deployment are disclosed. The method includes receiving at least one from among a first dataset from a first user and a second dataset from a second user. Next, the method includes analyzing, using a first model, the first dataset. Next, the method includes providing, to a second model, the analyzed first dataset and the second dataset. Next, the method includes executing, using the second model, a first set of tasks corresponding to the analyzed first dataset and a second set of tasks corresponding to the second dataset. Next, the method includes generating, using the second model, at least one from among a first pull request and a second pull request. Next, the method includes providing the at least one from among the first pull request and the second pull request to an entity for validation and ratification.

### CROSS-REFERENCE TO RELATED APPLICATIONS

This application claims priority benefit from Indian Application No. 202411096459, filed on Dec. 6, 2024, in the India Patent Office, which is hereby incorporated by reference in its entirety.

### FIELD OF THE DISCLOSURE

This technology generally relates to application development and testing, and more particularly relates to a method and system for performing analysis of code deployment for tuning the application optimization process.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With the advancement in technology, various organizations have embraced multi-cloud strategies, leading to growing concerns regarding financial operations (FinOps) and site reliability engineering (SRE) strategies. In such a complex environment, architects and developers face significant challenges in enhancing application performance, availability, maintenance, monitoring, and cost savings for organizations. The primary way to achieve cost savings is through application performance fine-tuning.

Presently, if an architect wants to take an initiative to make some migration plan, performance change, vulnerability fix, or any other prelaunch experimental code changes across a line of business (LOB) or an organization, it is too difficult to estimate the efforts or understand the impact of a code change on applications. The code change may need various directions to understand before initiating or releasing into all the applications or projects across the LOB. Such directions include various perspectives like performance, efforts, validation, or impact analysis. The shortcomings of existing methods underscore a need for an innovative approach to analyze the code deployment before releasing it over multiple applications across the LOB.

Hence, in view of these and other existing limitations, there arises an imperative need to provide an efficient solution to overcome the above-mentioned limitations and to provide a method and system to perform efficient analysis of code deployment for tuning the application optimization process.

### SUMMARY

The present disclosure, through one or more of its various aspects, embodiments, and/or specific features or sub-components, provides, inter alias, various systems, servers, devices, methods, media, programs, and platforms for performing analysis of code deployment.

According to an aspect of the present disclosure, a method for performing an analysis of a code deployment is disclosed. The method is implemented by at least one processor. The method includes receiving, by the at least one processor, at least one from among a first dataset associated with a first user and a second dataset associated with a second user. Next, the method includes analyzing, by the at least one processor using a first model, the first dataset to generate an analyzed first dataset. Next, the method includes providing, by the at least one processor to a second model, the analyzed first dataset and the second dataset. Next, the method includes executing, by the at least one processor using the second model, a first set of tasks corresponding to the analyzed first dataset and a second set of tasks corresponding to the second dataset. Next, the method includes generating, by the at least one processor using the second model, at least one from among a first pull request associated with the first user and a second pull request associated with the second user. Next, the method includes providing, by the at least one processor, the at least one from among the first pull request and the second pull request to an entity for validation and ratification.

In accordance with an exemplary embodiment, the first dataset may include code modifications to implement a library, and the second dataset may include code commits to implement changes on at least one application.

In an accordance with an exemplary embodiment, the method may further include analyzing, by the at least one processor using the first model, the code modifications in order to generate an estimation of an implementation effort required for applying the code modifications over the at least one application.

In accordance with an exemplary embodiment, the first set of tasks corresponding to the analyzed first dataset may include: integrating the code modifications to implement the library for a set of applications, generating test cases for the code modifications, executing the test cases, and performing a comparison between pre-implementation performance metrics and post-implementation performance metrics for the set of applications.

In accordance with an exemplary embodiment, the second set of tasks corresponding to the second dataset may include: performing a comparison of a plurality of metrics for the at least one application before the implementation of the changes with the plurality of metrics for the at least one application after the implementation after the implementation of the changes.

In accordance with an exemplary embodiment, the generation of the first pull request may be based on a successful execution of the first set of tasks.

In accordance with an exemplary embodiment, the first pull request may include a feedback on the code modifications.

In accordance with an exemplary embodiment, the second pull request may include a feedback on the code commits.

According to another aspect of the present disclosure, a computing device configured to implement an execution of a method for performing an analysis of a code deployment is disclosed. The computing device includes a processor; a memory; and a communication interface coupled to each of the processor and the memory. The processor may be configured to receive at least one from among a first dataset associated with a first user and a second dataset associated with a second user. Next, the processor may be configured to analyze, using a first model, the first dataset to generate an analyzed first dataset. Next, the processor may be configured to provide, to a second model, the analyzed first dataset and the second dataset. Next, the processor may be configured to execute, using the second model, a first set of tasks corresponding to the analyzed first dataset and a second set of tasks corresponding to the second dataset. Next, the processor may be configured to generate, using the second model, at least one from among a first pull request associated with the first user and a second pull request associated with the second user. Next, the processor may be configured to provide the at least one from among the first pull request and the second pull request to an entity for validation and ratification.

In accordance with an exemplary embodiment, the first dataset may include code modifications to implement a library, and the second dataset may include code commits to implement changes on at least one application.

In accordance with an exemplary embodiment, the processor may be further configured to analyze the code modifications using the first model in order to generate an estimation of an implementation effort required to apply the code modifications over the at least one application.

In accordance with an exemplary embodiment, the first set of tasks corresponding to the analyzed first dataset may include: integrating the code modifications to implement the library for a set of applications, generating test cases for the code modifications, executing the test cases, and performing a comparison between pre-implementation performance metrics and post-implementation performance metrics for the set of applications.

In accordance with an exemplary embodiment, the second set of tasks corresponding to the second dataset may include: performing a comparison of a plurality of metrics for the at least one application before the implementation of the changes with the plurality of metrics of the at least one application after the implementation of the changes.

In accordance with an exemplary embodiment, the generation of the first pull request may be based on a successful execution of the first set of tasks.

In accordance with an exemplary embodiment, the first pull request may include a feedback on the code modifications.

In accordance with an exemplary embodiment, the second pull request may include a feedback associated with the code commits.

According to yet another aspect of the present disclosure, a non-transitory computer-readable storage medium storing instructions for performing an analysis of a code deployment is disclosed. The instructions include executable code which, when executed by a processor, may cause the processor to receive at least one from among a first dataset associated with a first user and a second dataset associated with a second user; analyze, using a first model, the first dataset to generate an analyzed first dataset; provide, to a second model, the analyzed first dataset and the second dataset; execute, using the second model, a first set of tasks corresponding to the analyzed first dataset and a second set of tasks corresponding to the second dataset; generate, using the second model, at least one from among a first pull request associated with the first user and a second pull request associated with the second user; and provide the at least one from among the first pull request and the second pull request to an entity for validation and ratification.

In accordance with an exemplary embodiment, the first dataset may include code modifications to implement a library, and the second dataset may include code commits to implement changes on at least one application.

In accordance with an exemplary embodiment, when executed, the executable code may further cause the processor to analyze the code modifications using the first model and in order to generate an estimation of an implementation effort required to apply the code modifications over the at least one application.

In accordance with an exemplary embodiment, the first set of tasks corresponding to the analyzed first dataset may include: integrating the code modifications to implement the library for a set of applications; generating test cases for the code modifications; executing the test cases; and performing a comparison between pre-implementation performance metrics and post-implementation performance metrics for the set of applications.

In accordance with an exemplary embodiment, the second set of tasks corresponding to the second dataset may include: performing a comparison of a plurality of metrics for the at least one application before the implementation of the changes with the plurality of metrics for the at least one application after the implementation of the changes.

In accordance with an exemplary embodiment, the generation of the first pull request may be based on a successful execution of the first set of tasks.

In accordance with an exemplary embodiment, the first pull request may include a feedback on the code modifications.

In accordance with an exemplary embodiment, the second pull request may include a feedback associated with the code commits.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for performing an analysis of a code deployment, in accordance with an exemplary embodiment of the present disclosure.

FIG. 2 illustrates an exemplary diagram of a network environment for performing an analysis of a code deployment, in accordance with an exemplary embodiment of the present disclosure.

FIG. 3 illustrates an exemplary system for performing an analysis of a code deployment, in accordance with an exemplary embodiment of the present disclosure.

FIG. 4 illustrates an exemplary method flow diagram for performing an analysis of a code deployment, in accordance with an exemplary embodiment of the present disclosure.

FIG. 5 illustrates an architecture of a system for performing an analysis of a code deployment, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of methods or systems that can offer an automatic analysis of a code deployment across multiple applications. Currently, code deployment analysis is performed manually by developers, making the process time-consuming and labor-intensive. Additionally, the existing solutions fail to estimate an impact of the code change on applications across an organization or a line of business (LOB).

The present disclosure solves the aforementioned problems by providing a method and a system for performing an analysis of the code deployment. In the present disclosure, at first, the system receives at least one from among a first dataset associated with a first user and a second dataset associated with a second user. Further, the system analyzes, using a first model, the first dataset to generate an analyzed first dataset. Further, the system provides, to a second model, the analyzed first dataset and the second dataset. Further, the system executes, using the second model, a first set of tasks corresponding to the analyzed first dataset and a second set of tasks corresponding to the second dataset. Further, the system generates, using the second model, at least one from among a first pull request associated with the first user and a second pull request associated with the second user. Thereafter, the system provides the at least one from among the first pull request and the second pull request to an entity for validation and ratification.

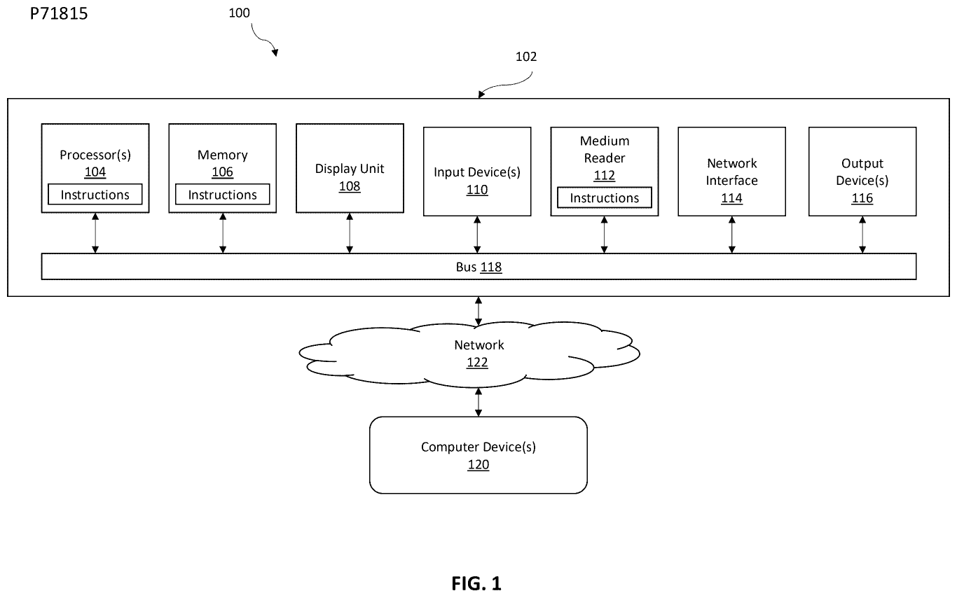

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for performing an analysis of a code deployment.

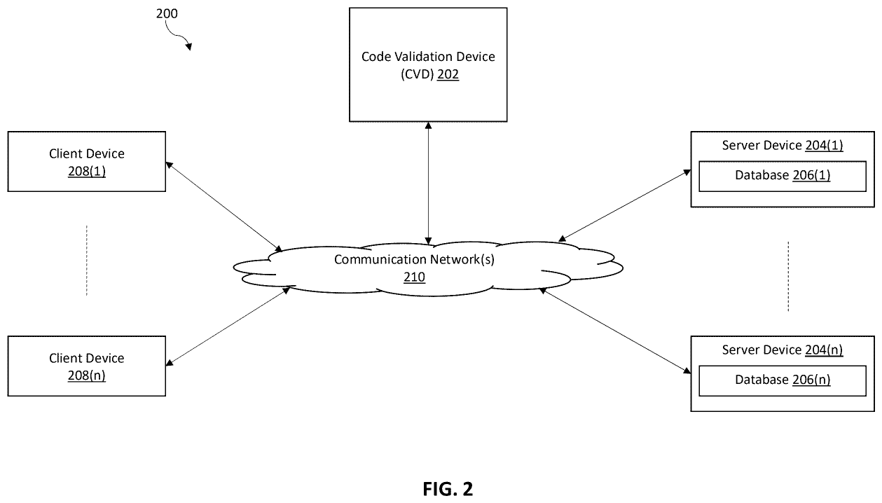

Referring to FIG. 2, a schematic of an exemplary network environment 200 for performing an analysis of a code deployment is illustrated. In an exemplary embodiment, the method is executable on any networked computer platform, such as, for example, a personal computer (PC).

The method for performing an analysis of a code deployment may be executed by a code validation device (CVD) 202. The CVD 202 may be the same or similar to the computer system 102 as described with respect to FIG. 1. The CVD 202 may store one or more applications that may include executable instructions that, when executed by the CVD 202, cause the CVD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the CVD 202 itself, may be located in the virtual server(s) running in a cloud-based computing environment rather than being tied to one or more specific physical network computing devices. Also, the application(s) may be running in one or more virtual machines (VMs) executing on the CVD 202. Additionally, in one or more embodiments of this technology, virtual machine(s) running on the CVD 202 may be managed or supervised by a hypervisor.

In the network environment 200 of FIG. 2, the CVD 202 is coupled to a plurality of server devices 204(1)-204(n) that hosts a plurality of databases 206(1)-206(n), and also to a plurality of client devices 208(1)-208(n) via communication network(s) 210. A communication interface of the CVD 202, such as the network interface 114 of the computer system 102 of FIG. 1, operatively couples and communicates between the CVD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CVD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and CVDs that efficiently implement the method for performing an analysis of a code deployment.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The CVD 202 may be a standalone device or integrated with one or more other devices or apparatuses, such as one or more of the server devices 204(1)-204(n), for example. In one particular example, the CVD 202 may include or be hosted by one of the server devices 204(1)-204(n), and other arrangements are also possible. Moreover, one or more of the devices of the CVD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the CVD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data associated with the code deployment.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment, and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CVD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the CVD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the CVD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CVD 202, the server devices 204(1)-204(n), or the client devices 208(1)-208(n), for example, may be configured to operate as virtual instances on the same physical machine. In other words, one or more of the CVD 202, the server devices 204(1)-204(n), or the client devices 208(1)-208(n) may operate on the same physical device rather than as separate devices communicating through communication network(s) 210. Additionally, there may be more or fewer CVDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

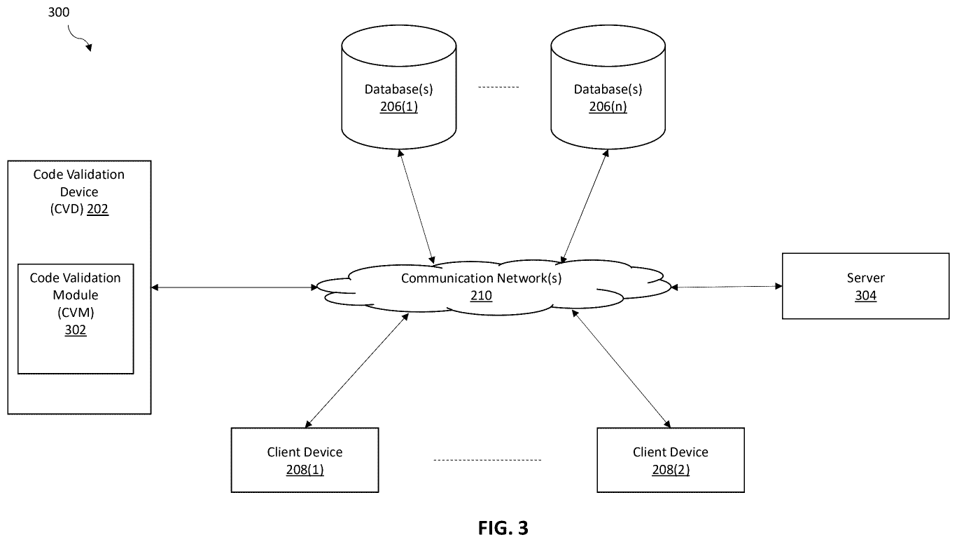

FIG. 3 illustrates a system diagram for implementing a method for performing an analysis of a code deployment, in accordance with an exemplary embodiment.

As illustrated in FIG. 3, the system 300 may include a code validation device (CVD) 202 within which a code validation module (CVM) 302 is embedded, a server 304, a database(s) 206(1) . . . 206(n), a plurality of client devices 208(1) . . . 208(2), and a communication network(s) 210.

According to exemplary embodiments, the CVD 202 including the CVM 302 may be connected to the server 304, and the database(s) 206(1) . . . 206(n) via the communication network(s) 210, but the disclosure is not limited thereto. The CVD 202 may also be connected to the plurality of client devices 208(1) . . . 208(2) via the communication network 210, but the disclosure is not limited thereto. The database(s) 206(1) . . . 206(n) may include rule database.

In an embodiment, the CVD 202 is described and shown in FIG. 3 as including the CVM 302, although it may include other rules, policies, modules, databases, or applications, for example. As will be described below, the CVM 302 is configured to implement a method for performing an analysis of a code deployment.

An exemplary system 300 for implementing a mechanism to perform an analysis of a code deployment by utilizing the network environment of FIG. 2 is shown as being executed in FIG. 3. Specifically, a first client device 208(1) and a second client device 208(2) are illustrated as being in communication with the CVD 202. In this regard, the first client device 208(1) and the second client device 208(2) may be “clients” of the CVD 202 and are described herein as such. Nevertheless, it is to be known and understood that the first client device 208(1) and/or the second client device 208(2) need not necessarily be “clients” of the CVD 202, or any entity described in association therewith herein. Any additional or alternative relationship may exist between either or both of the first client device 208(1) and the second client device 208(2) and the CVD 202, or no relationship may exist.

Further, the CVD 202 is illustrated as being able to access one or more databases 206(1) . . . 206(n). The CVM 302 may be configured to access these repositories/databases for implementing a method for performing an analysis of a code deployment. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the CVD 202 via broadband or cellular communication. These embodiments are merely exemplary and are not limiting or exhaustive.

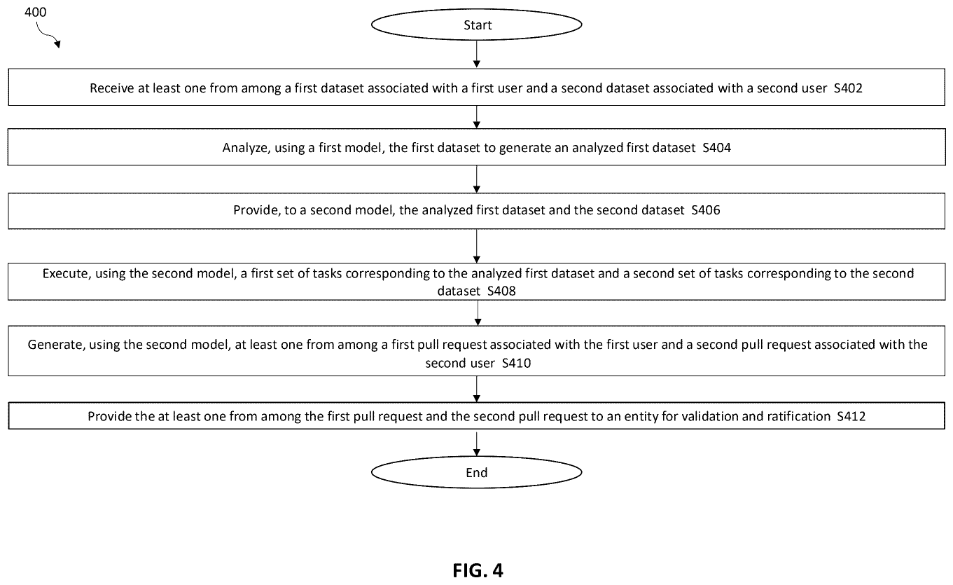

Referring to FIG. 4, an exemplary method 400 is shown to perform an analysis of a code deployment, in accordance with an exemplary implementation.

As shown in FIG. 4, the method 400 begins following a need to develop a method for performing an analysis of code changes across multiple applications utilized by an organization or a line of business (LOB) to ensure seamless integration of such changes into such applications. The method 400 is implemented by at least one processor 104.

At step S402, the method 400 includes receiving, by the at least one processor 104, at least one from among a first dataset from a first user and a second dataset from a second user. The first dataset includes code modifications to implement a library (e.g., a new library), and the second dataset includes code commits to implement changes on at least one application.

In an implementation, the first user is an architect or a member of a lead development authority (LDA). The second user is a developer.

The term “architect” herein may correspond to a person who is involved in developing or implementing a library (e.g., a new library such as a logger library) across an organization or a line of business to optimize organization-wide development and productivity. The term “developer” is a professional who designs, creates, evaluates, and maintains software applications or systems. The developer aims to deliver changes with details of their impact on memory usage for better resource management.

A code commit is a fundamental operation in systems where a set of changes to a codebase is recorded as a new revision in the repository. Code modifications refer to alterations made to the source code of a software project. The term “application” herein may correspond to a software program or a tool that is designed to receive input from the user and provide output to the user.

The at least one processor 104 may receive the first dataset and the second dataset in the form of code deployment data such as code blocks or code commits. The first dataset includes the code modifications to implement the library (e.g., a new library) and the second dataset includes the code commits to implement changes to the at least one application. The code commits may include code changes performed by a developer for the at least one application. It will be appreciated by the person skilled in the art that the aim here is to create a system that performs an analysis of a code deployment to fine-tune application optimization process across the LOB.

At step S404, the method includes analyzing, by the at least one processor 104 using a first model, the first dataset to generate an analyzed first dataset.

The method includes analyzing, by the at least one processor 104 using the first model, the code modifications in order to generate an estimation of an implementation effort required for applying the code modifications over the at least one application. In an implementation, the first model is an artificial intelligence (AI) model, and the AI model is configured to analyze the code modifications necessary to implement the new library.

When the first user provides code modifications necessary to implement a new library to the AI model, the at least one processor 104 using the AI model analyzes the code modifications and generates an estimation of an implementation effort (e.g., time required for such modifications, impact on resources, etc.) required for all applications throughout the organization for such code modifications. Based on the estimation provided by the AI model, the first user makes a decision and the at least one processor 104 then triggers a second model (e.g., an incubator model) upon reception of a positive response from the first user in response to the provided estimation.

At step S406, the method includes providing, by the at least one processor 104 to the second model, the analyzed first dataset and the second dataset.

In an exemplary implementation, the second model is an incubator module. The second model may function as a specialized component or framework within a software development environment designed to facilitate the creation, development, and deployment of applications.

In an example, when the first user makes a decision on the estimation, the at least one processor 104 transmits the analyzed first dataset and the second dataset to the second model.

At step S408, the method includes executing, by the at least one processor 104, using the second model, a first set of tasks corresponding to the analyzed first dataset and a second set of tasks corresponding to the second dataset.

In an embodiment, the first set of tasks for the analyzed first dataset may include any one or more of the following: integrating the code modifications to implement the library for a set of applications; generating test cases for the code modifications; executing the test cases; and performing a comparison between pre-implementation performance metrics and post-implementation performance metrics for the set of applications.

In an embodiment, the second set of tasks for the second dataset may include: performing a comparison of a plurality of metrics (e.g., monitoring metrics) for the at least one application before the implementation of the changes with the plurality of metrics after the implementation of the changes. The plurality of metrics may include open connection counts, open thread counts, memory used to run the application, memory used for storing the necessary data, request and response time for each request, log difference between previous run versus new run, and request and response sizes.

In an example, when the first user (such as the architect or LDA) provides the first dataset to initiate a library integration process for a sample of applications (or the set of applications), the at least one processor 104 causes the second model to accomplish such a library integration process. The second model further executes the library integration process by pulling the latest code from repositories for the set of applications, implementing necessary changes for such latest code, writing test cases to cover a new code, and running such test cases. Upon successful execution of the test cases, the at least one processor 104 further causes the second model to compare the pre-implementation performance metrics and post-implementation performance metrics for the set of applications.

In another example, once the second user such as the developer commits the code, the at least one processor 104 triggers the second model. The at least one processor 104 using the second model executes all necessary steps and performs a comparison of a plurality of metrics for the at least one application before the implementation of the changes with the plurality of metrics after the implementation of the changes.

At step S410, the method includes generating, by the at least one processor 104 using the second model, at least one from among a first pull request associated with the first user and a second pull request associated with the second user.

The generation of the first pull request is based on a successful execution of the first set of tasks. The first pull request includes a code modification feedback. The second pull request includes a code commit feedback. The code modification feedback and the code commit feedback may include necessary improvements to the code modifications or the code commits, respectively.

At step S412, the method includes providing, by the at least one processor 104, the at least one from among the first pull request and the second pull request to an entity for validation and ratification.

In an example, if the first set of tasks are successfully executed, then the at least one processor 104, using the second model, generates the first pull request associated with the first user for the entity (such as the development team or a developer) which further determines acceptance or rejection of the feedback (e.g., improvements to the code modifications such as code blocks) included in the first pull request. It is to be noted that the entity can be a senior developer or development team who reviews the pull request and moves forward with the code deployment release. The entity refers to a code reviewer or a group of developers who work together on software projects. They collaborate to review code, make decisions about changes, and manage the overall development process.

If the second set of tasks are successfully executed, then at least one processor 104, using the second model, generates the second pull request for the entity (such as the development team) which further determines acceptance or rejection of the feedback (e.g., improvements to the code commits) included in the second pull request.

In an exemplary implementation, a virtual assistant (also referred to as a digital assistant) utilizes a trained model (e.g., an artificial intelligence (AI) model) to analyze and suggest efficient code blocks, promoting code maturity and performance in the organization. The virtual assistant may have trained itself by utilizing both external and internal data associated with the organization. When the virtual assistant identifies potential code improvements in code modifications or code commits received from the user (e.g., an architect or a developer), it executes its experimental code in the second model during a predefined time period (e.g., non-peak hours of a day). Once the second model processes the code modifications or the code commits, it follows the established workflow and makes a decision of pull request generation using a pre-and-post comparator module. Afterward, the second model generates and sends a pull request to the entity (e.g., a developer or a developer team) suggesting necessary code improvements for the code modifications or code commits.

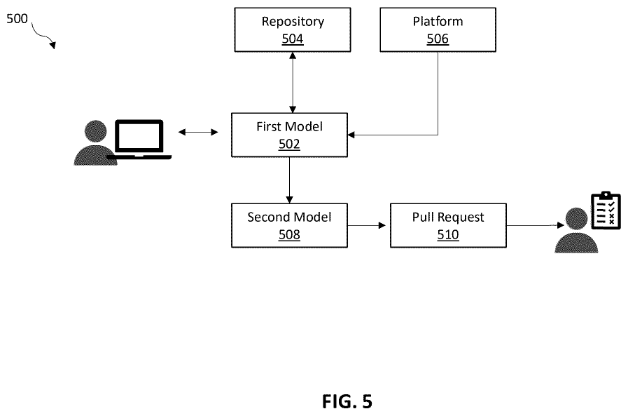

FIG. 5 illustrates an architecture of a system for performing an analysis of a code deployment, in accordance with an exemplary implementation of the present disclosure. As illustrated in FIG. 5, the process flow 500 begins with receiving at least one from among a first dataset associated with a first user and a second dataset associated with a second user. The first user and the second user may transmit the first dataset and the second dataset respectively by using their associated computing devices. As used herein, the computing device may be selected from but is not limited to, a laptop, a smartphone, and a tablet. The first dataset includes at least one from among code modifications to implement a library and the second dataset includes code commits to implement changes on at least one application.

In an exemplary implementation, when the first user provides code modifications necessary to implement the new library to a first model 502 (e.g., an artificial intelligence (AI) model), at least one processor 104 utilizes the first model 502 to analyze the code modifications in order to generate an estimation of implementation effort required for all applications throughout an organization or a line of business (LOB). The first model 502 is trained using a repository 504 (e.g., a bitbucket® repository). The repository 504 acts as a code repository. The first model 502 is also connected with a platform 506 (e.g., terraform). The platform 506 contains infrastructure such as hardware information for the at least one application. The platform 506 helps to identify the hardware related info to run the at least one application.

Based on the estimation provided by the first model 502 to the first user, the first user makes a decision (e.g., an approval to proceed further or a rejection to terminate the process). Thereafter, upon receiving approval from the first user, the first model 502 triggers a request for a second model 508 (e.g., an incubator model).

In an exemplary implementation, the second model 508 is the incubator model. Further, the at least one processor 104 using the second model 508 executes a first set of tasks for the analyzed first dataset and a second set of tasks for the second dataset. The second model 508 may function as a specialized component or framework within a software development environment designed to facilitate the creation, development, and deployment of applications.

In another exemplary implementation, once the second user such as the developer commits the code, the at least one processor 104 triggers the second model 508. The at least one processor 104 using the second model 508 performs a comparison of a plurality of metrics for the at least one application before and after the implementation of the code commits. The plurality of metrics (e.g., monitoring metrics) may include open connection counts, open thread counts, memory used to run the application, memory used for storing the necessary data, request and response time for each request, failure warning (if any), log difference between previous run vs new run, and request and response sizes.

Further, the at least one processor 104 using the second model 508 generates a pull request 510, which may include at least one of a first pull request for the first user and a second pull request for the second user. The generation of the first pull request is based on a successful execution of the first set of tasks. The first pull request includes a feedback on the code modifications. The second pull request includes a feedback on the code commits.

Further, the at least one processor 104 provides the pull request 510, i.e., the at least one from among the first pull request and the second pull request, to an entity for validation and ratification. The first pull request includes a feedback on the code modifications. The second pull request includes a feedback on the code commits. The entity may be a developer or a developer team that ratifies feedback (such as necessary improvements in code modifications or code commits) included in the first pull request and the second pull request. This way the present system performs the analysis of the code deployment for tuning of application optimization process. Hence, the disclosed system helps in streamlining the process of code deployment within a production environment. The disclosed system enables architects or developers to efficiently estimate the efforts and resources required for smoother implementation of any new code deployment across at least one application by providing the feedback on the code commits and code modifications. The developer can estimate the efforts and resources required to implement the new code deployment based on the complexity and scale of the changes made and the plurality of metrics.

For example, when developers submit code commits for the new feature (e.g., a user profile customization), the system automatically analyzes the changes and provides the feedback on potential issues. For example, it could flag any code that may result in slow database queries, missing tests, or inconsistent application programming interface (API) responses. This feedback allows developers to quickly identify the potential risks before the code reaches the production stage.

The present disclosure provides numerous advantages as given below. The present disclosure provides a method that can perform an analysis of a code deployment. The present method allows an architect to adapt a new library for a set of applications used across an organization or a line of business (LOB). The present disclosure offers a practical approach to analyze code deployment along with a feedback suggesting improvements in such code deployments. The present disclosure provides improved application performance, optimizing application resource usage enhances performance which leads to faster load times and responsiveness. The method helps in achieving better-performing applications ensuring high availability, minimizing the risk of outages and downtime. The method disclosed in the present disclosure helps with efficient resource allocation and streamlines the code deployment process due to reduced operational costs. The present disclosure provides a streamlined process that enables an architect to efficiently estimate the effort and resources required for firm-wide library integration, leading to better decision-making and smoother implementation. The method disclosed in the present disclosure also helps in identifying the impact of a code change proposed by a developer on the infrastructure of the organization and the cost analysis for such a code change.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to perform an analysis of a code deployment is disclosed. The instructions include executable code which, when executed by a processor 104, may cause the processor 104 to receive at least one from among a first dataset associated with a first user and a second dataset associated with a second user; analyze, using a first model, the first dataset to generate an analyzed first dataset; provide, to a second model, the analyzed first dataset and the second dataset; execute, using the second model, a first set of tasks for the analyzed first dataset and a second set of tasks corresponding to the second dataset; generate, using the second model, at least one from among a first pull request associated with the first user and a second pull request associated with the second user; and provide the at least one from among the first pull request and the second pull request to an entity for validation and ratification.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for performing an analysis of a code deployment, the method being implemented by at least one processor, the method comprising:
receiving, by the at least one processor, at least one from among a first dataset associated with a first user and a second dataset associated with a second user;
analyzing, by the at least one processor using a first model, the first dataset to generate an analyzed first dataset;
providing, by the at least one processor to a second model, the analyzed first dataset and the second dataset;
executing, by the at least one processor using the second model, a first set of tasks corresponding to the analyzed first dataset and a second set of tasks corresponding to the second dataset;
generating, by the at least one processor using the second model, at least one from among a first pull request associated with the first user and a second pull request associated with the second user; and
providing, by the at least one processor, the at least one from among the first pull request and the second pull request to an entity for validation and ratification.

2. The method as claimed in claim 1, wherein the first dataset comprises code modifications to implement a library, and the second dataset comprises code commits to implement changes on at least one application.

3. The method as claimed in claim 2, further comprising analyzing, by the at least one processor using the first model, the code modifications in order to generate an estimation of an implementation effort required for applying the code modifications over the at least one application.

4. The method as claimed in claim 2, wherein the first set of tasks corresponding to the analyzed first dataset comprises: integrating the code modifications to implement the library for a set of applications, generating test cases for the code modifications, executing the test cases, and performing a comparison between pre-implementation performance metrics and post-implementation performance metrics for the set of applications.

5. The method as claimed in claim 2, wherein the second set of tasks corresponding to the second dataset comprises: performing a comparison of a plurality of metrics for the at least one application before the implementation of the changes with the plurality of metrics for the at least one application after the implementation of the changes.

6. The method as claimed in claim 1, wherein the generation of the first pull request is based on a successful execution of the first set of tasks.

7. The method as claimed in claim 2, wherein the first pull request comprises a feedback on the code modifications.

8. The method as claimed in claim 2, wherein the second pull request comprises a feedback associated with the code commits.

9. A computing device configured to perform an analysis of a code deployment, the computing device comprising:
a processor;
a memory; and
a communication interface coupled to each of the processor and the memory, wherein the processor is configured to:
receive at least one from among a first dataset associated with a first user and a second dataset associated with a second user;
analyze, using a first model, the first dataset to generate an analyzed first dataset;
provide, to a second model, the analyzed first dataset and the second dataset;
execute, using the second model, a first set of tasks corresponding to the analyzed first dataset and a second set of tasks corresponding to the second dataset;
generate, using the second model, at least one from among a first pull request associated with the first user and a second pull request associated with the second user; and
provide the at least one from among the first pull request and the second pull request to an entity for validation and ratification.

10. The computing device as claimed in claim 9, wherein the first dataset comprises code modifications to implement a library, and the second dataset comprises code commits to implement changes on at least one application.

11. The computing device as claimed in claim 10, wherein the processor is further configured to analyze the code modifications using the first model in order to generate an estimation of an implementation effort required to apply the code modifications over the at least one application.

12. The computing device as claimed in claim 10, wherein the first set of tasks for the analyzed first dataset comprises: integrating the code modifications to implement the library for a set of applications, generating test cases for the code modifications, executing the test cases, and performing a comparison between pre-implementation performance metrics and post-implementation performance metrics for the set of applications.

13. The computing device as claimed in claim 10, wherein the second set of tasks for the second dataset comprises: performing a comparison of a plurality of metrics for the at least one application before the implementation of the changes with the plurality of metrics for the at least one application after the implementation of the changes.

14. The computing device as claimed in claim 9, wherein the generation of the first pull request is based on a successful execution of the first set of tasks.

15. The computing device as claimed in claim 10, wherein the first pull request comprises a feedback on the code modifications.

16. The computing device as claimed in claim 10, wherein the second pull request comprises a feedback associated with the code commits.

17. A non-transitory computer readable storage medium storing instructions for performing an analysis of a code deployment, the storage medium comprising executable code which, when executed by a processor, causes the processor to:
receive at least one from among a first dataset associated with a first user and a second dataset associated with a second user;
analyze, using a first model, the first dataset to generate an analyzed first dataset;
provide, to a second model, the analyzed first dataset and the second dataset;
execute, using the second model, a first set of tasks corresponding to the analyzed first dataset and a second set of tasks corresponding to the second dataset;
generate, using the second model, at least one from among a first pull request associated with the first user and a second pull request associated with the second user; and
provide the at least one from among the first pull request and the second pull request to an entity for validation and ratification.

18. The storage medium as claimed in claim 17, wherein the first dataset comprises code modifications to implement a library, and the second dataset comprises code commits to implement changes on at least one application.

19. The storage medium as claimed in claim 18, wherein when executed, the executable code further causes the processor to analyze the code modifications using the first model and in order to generate an estimation of an implementation effort required to apply the code modifications over the at least one application.

20. The storage medium as claimed in claim 18, wherein the first set of tasks corresponding to the analyzed first dataset comprises: integrating the code modifications to implement the library for a set of applications, generating test cases for the code modifications, executing the test cases, and performing a comparison between pre-implementation performance metrics and post-implementation performance metrics for the set of applications.
